(19) United States
(12) Patent Application Publication
(10) Pub. No.: US 2016/0112781 A1
(43) Pub. Date: Apr. 21, 2016

(54) ELECTRONIC DEVICE HAVING MAXIMUM MOUNTING SPACE ON CIRCUIT BOARD

(71) Applicant: Samsung Electronics Co., Ltd., Gyeonggi-do (KR)

(72) Inventors: Minsung LEE, Gyeonggi-do (KR); Taedoo CHOUNG, Gyeonggi-do (KR)

(21) Appl. No.: 14/882,647

(22) Filed: Oct. 14, 2015

(30) Foreign Application Priority Data
Oct. 15, 2014 (KR) 10-2014-0139271

(51) Int. Cl. H04R 1/02

(52) U.S. Cl. CPC H04R 1/021

(57) ABSTRACT

An electronic device having a speaker may include: a first housing; a circuit board disposed inside the first housing; and a second housing attached to a top surface of the circuit board, wherein the circuit board includes a first shape sealing line and a second shape sealing line that form a sealing region.

### CLAIM OF PRIORITY

The present application claims the benefit under 35 U.S.C. §119(a) of Korean patent application filed on Oct. 15, 2014 in the Korean Intellectual Property Office and assigned Serial number 10-2014-0139271, the entire contents of which is hereby incorporated by reference.

### BACKGROUND

1. Technical Field

The present disclosure generally relates to an electronic device having a speaker, and more particularly, to an electronic device having a maximum mounting space on a circuit board, in which a speaker may be mounted to a main cover through a direct assembly method, a mounting space on a circuit board may be maximized, and a resonance space for a speaker sound may be created.

2. Description of the Related Art

As well-known in the art, a portable electronic device, such as a mobile communication terminal or a portable multimedia device, employs a method of directly mounting a speaker on a main cover without using a separate module in order to reduce a material cost and to maximize a speaker performance.

In addition, some models of portable electronic devices, i.e. high-end level models of electronic devices employ a half circuit board having a half size as compared to an existing circuit board or various shapes of circuit boards, such as a [symbol] -shaped circuit board and a [symbol] -shaped circuit board. The half circuit board or the various shapes of circuit boards may facilitate reducing the thickness of the electronic devices as they do not overlap a battery on a Z-axis.

However, when the speaker is directly mounted on the half circuit board or other variously shaped circuit boards, without using a separate module, it is impossible to secure a proper speaker performance in view of the thickness.

As a result, conventionally, the direct assembly method is not used when trying to secure or mount a speaker. If it were adapted for this purpose, a sealing structure would be required which would reduce the mounting space on the circuit board for the speaker.

Thus problems associating with using a half-module speaker structure for directly fixing a speaker to a mechanical housing from the half circuit board or the variously shaped circuit boards includes having insufficient mounting height for the speaker. To create sufficient mounting space, it is necessary to cut the circuit board at a portion that corresponds to a speaker mounting portion and a resonance space. However, there are problems in that the mounting space on the circuit board is reduced by the cut portion and reduction of the resonance space for the speaker sound is inevitable.

It is to be understood that the statements provided in the background section provide information related to the present disclosure and should not be construed as constituting prior art.

### SUMMARY

The present disclosure addresses at least some of the problems described above. One object of the present disclosure is to: (a) provide an electronic device in which a speaker may be mounted to a main cover through a direct assembly method; (b) provide a mounting space on a circuit board may be maximized; and (c) provide a resonance space for a speaker sound.

Another object of the present disclosure is to provide an electronic device having a maximum mounting space on a circuit board, which enables reduction of a material cost and allows a design to be made in consideration of manufacturability

### (Design for Manufacturing (DFM)), Productivity, or Processes.

In accordance with an aspect of the present disclosure, an electronic device having a speaker may comprise: a first housing; a circuit board disposed inside the first housing; and a second housing attached to a top surface of the circuit board, wherein the circuit board includes a first shape sealing line and a second shape sealing line that form a sealing region.

The first shape sealing line and the second shape sealing line may be formed on the top and bottom surfaces of the circuit board, respectively.

The first shape sealing line may be formed in a shape that corresponds to that of a speaker module so as to directly mount the speaker module in the first housing and to form a resonance space on the bottom surface of the circuit board.

The first shape sealing line may include various shape portions formed by straight lines or curved lines.

The second shape sealing line may be formed in a shape that corresponds to that of the second housing in order to form a resonance space on the top surface of the circuit board.

The second shape sealing line may include various shape portions formed by straight lines or curved lines.

A bottom surface sealing member may be formed along a peripheral edge of the first shape sealing line.

A top surface sealing member may be formed along a peripheral edge of the second shape sealing line.

A Z-axis position of the speaker board may overlap that of the speaker.

The speaker module may be or include a half-module speaker.

These and other aspects of the present disclosure are further described with reference to the accompanying drawings.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a plan view illustrating a first housing in an electronic device having a maximum mounting space on a circuit board according to one embodiment of the present disclosure;

FIG. 2 is a plan view illustrating a second housing;

FIG. 3 is a plan view of the circuit board;

FIG. 4 is a bottom view of the circuit board;

FIG. 5 is a plan view illustrating a state in which the circuit board of FIG. 4 is coupled to the second housing of FIG. 2;

FIG. 6 is a plan view illustrating a state in which the circuit board of FIG. 3 is coupled to the first housing of FIG. 1; and

FIG. 7 is a sectional view illustrating a speaker mounting state in the electronic device having a maximum mounting space on a circuit board according to the embodiment of the present disclosure.

### DETAILED DESCRIPTION

Hereinafter, the present disclosure will be described in detail with reference to the accompanying drawings. The present disclosure may have various embodiments, and modifications and changes may be made therein without departing from the scope and sprit of the present disclosure. Therefore, it should be understood that there is no intent to limit the present disclosure to the particular forms, and the present disclosure should be construed to cover all modifications, equivalents, and/or alternatives falling within the spirit and scope of the present disclosure. In describing the drawings, the same or similar elements are designated by similar reference numerals.

In this disclosure, an electronic device may be a device that involves a communication function. For example, an electronic device may be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, electronic tattoos, an electronic appcessory, or a smart watch).

The terms that may be used in describing various embodiments of the present disclosure, such as “top surface,” “upper portion,” “bottom surface,” “lower portion,” “left upper side,” and “right lower side,” may be interpreted as being determined with reference to a certain constituent element on a drawing.

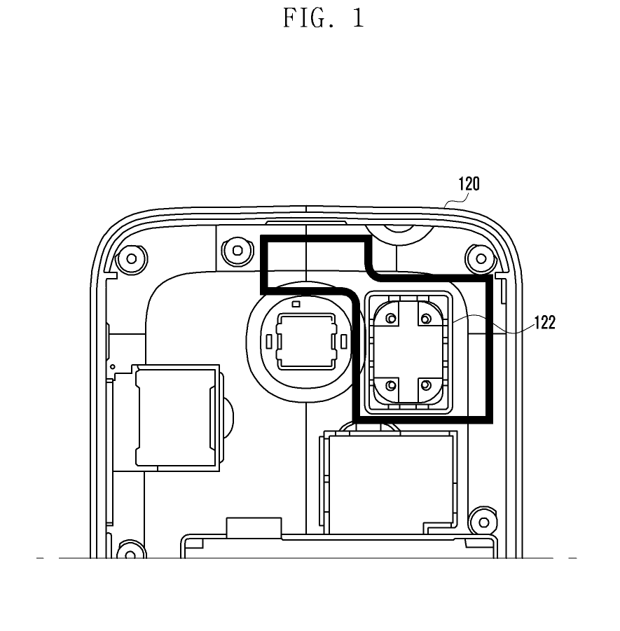

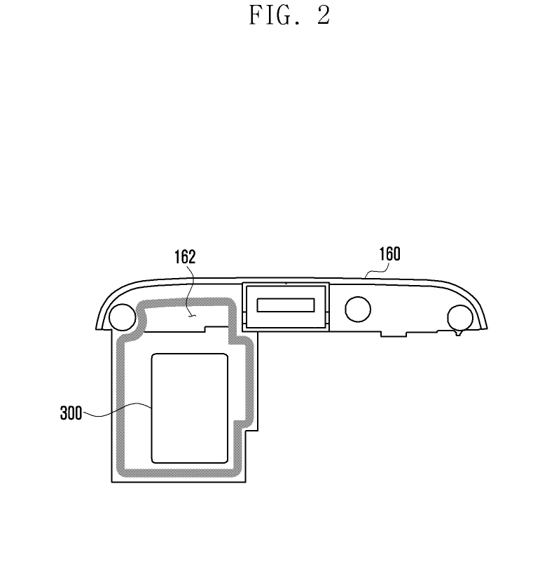

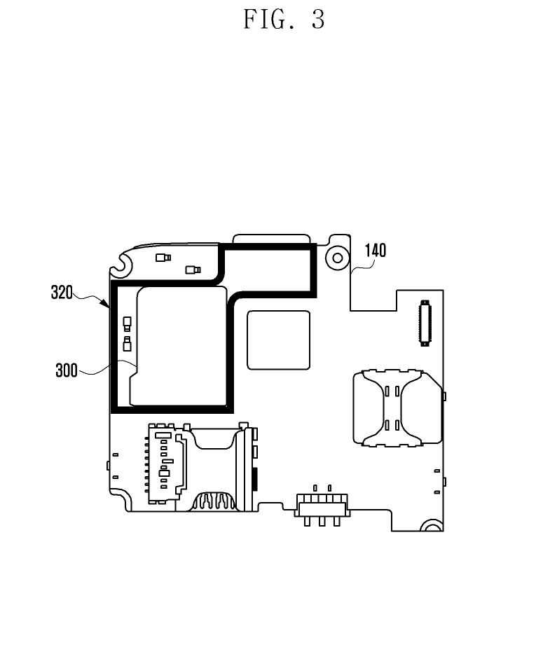

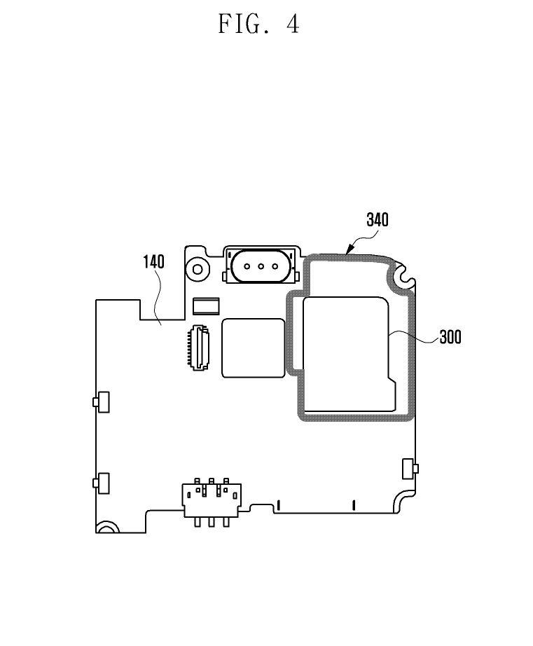

FIG. 1 illustrates a first housing in an electronic device having a maximum mounting space on a circuit board according to one embodiment of the present disclosure, FIG. 2 is a plan view illustrating a second housing, and FIGS. 3 and 4 illustrate plan and bottom views of the circuit board, respectively.

As illustrated in FIGS. 1 to 4, according to one embodiment of the present disclosure, an electronic device, which has the maximum mounting space on a circuit board, may employ a half circuit board having a half size as compared to an existing circuit board or various shapes of circuit boards, such as a [symbol] -shaped circuit board and a [symbol] -shaped circuit board.

In the following description, the term, “circuit board 140” may refer to the half circuit board or the various shapes of circuit boards such as the [symbol] -shaped circuit board and the [symbol] -shaped circuit board.

The circuit board 140 may be disposed within a first housing 120. A second housing 160, such as a tummy top, may be attached or coupled to a top surface of the circuit board 140 that may be attached or coupled to the first housing 120.

Therefore, the first housing 120 and the second housing 160 may be stacked from the lower portion, and the circuit board 140 be disposed between the first housing 120 and the second housing 160 such that: (a) a speaker mounting portion 122 may be formed between the first housing 120 and the circuit board 140; and (b) a resonance space 162 may be formed between the circuit board 140 and the second housing 160.

In order to form each of the speaker mounting portion 122 and the resonance space 162 between the first housing 120 and the second housing 160, the circuit board 140 may include a cutout 300 formed by cutting the circuit board 140 and a sealing region that is provided around the cutout 300 to form the speaker mounting portion 122 and the resonance space 162, respectively.

In the drawings, the sealing region, in which the speaker mounting portion 122 and the resonance space 162 are formed, is indicated by a bold line.

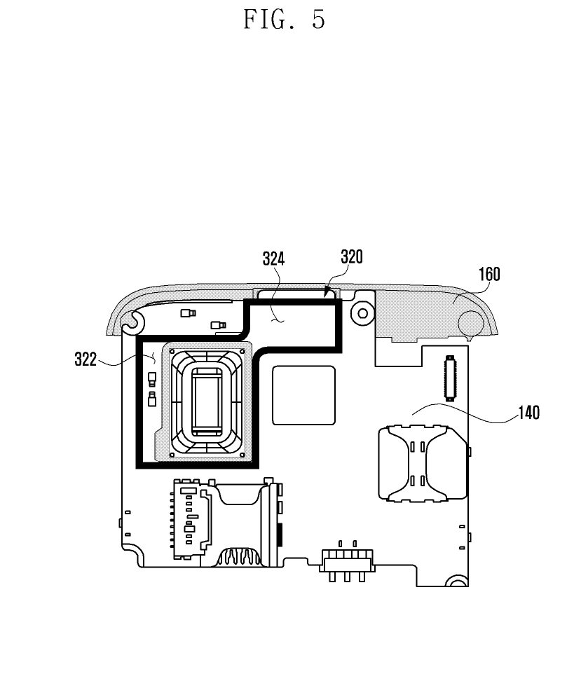

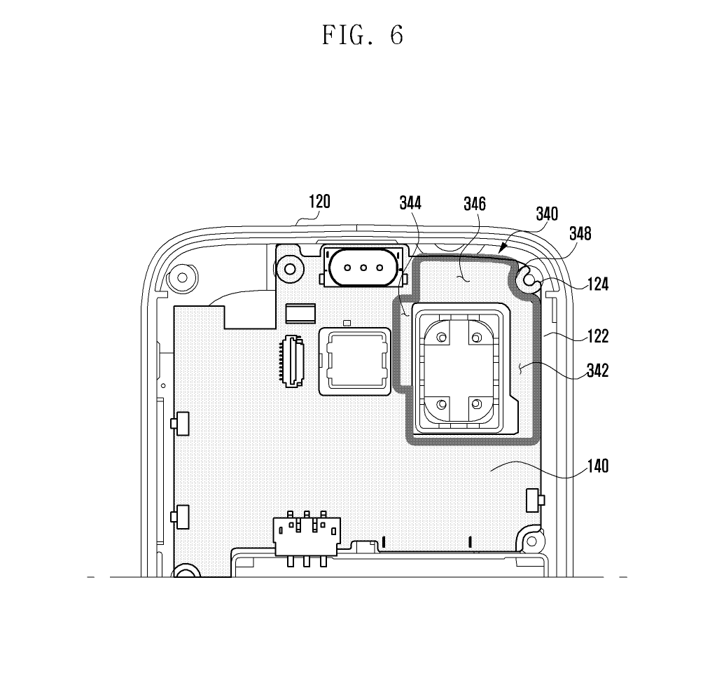

FIG. 5 illustrates a state in which the circuit board of FIG. 4 is attached or coupled to the second housing of FIG. 2, and FIG. 6 illustrates a state in which the circuit board of FIG. 3 is attached or coupled to the first housing of FIG. 1.

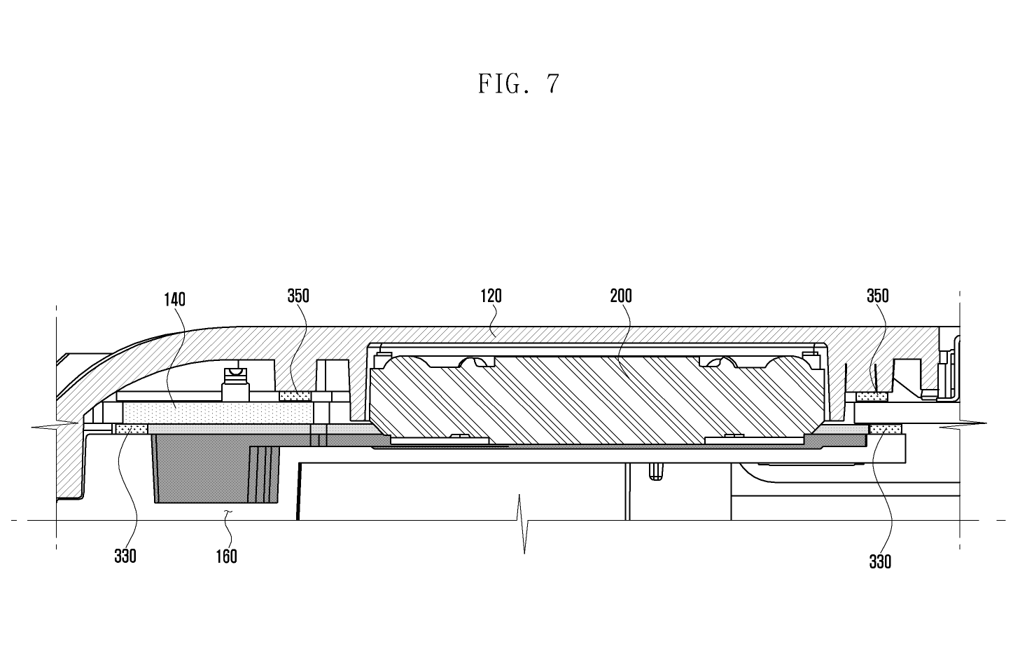

Referring to FIGS. 5 and 6, the sealing region of the circuit board 140 may include a first shape sealing line 320 for mounting a speaker module 200 (FIG. 7) and a second shape sealing line 340 for securing a resonance space.

The first shape sealing line 320 may be formed on the bottom surface of the circuit board 140, and the second shape sealing line 340 may be formed on the top surface of the circuit board 140.

The first shape sealing line 320 formed on the bottom surface of the circuit board 140 may be formed in a shape corresponding to that of a speaker module so as to faciliate directly mounting the speaker module 200 in the first housing 120, as well as to form a resonance space on the bottom surface of the circuit board 140.

The speaker module 200 may include various shape portions formed by straight lines and curved lines.

For example, in a case where the speaker module 200 has a shape in which the right lower corner of a rectangle is communicated with the left upper corner of a square, the first shape sealing line 320 may include a square shape portion 322 and a rectangular shape portion 324, of which the right lower corner is communicated with the left upper corner of the square shape portion 322 (as would be viewed from the front of the device (i.e., the opposing side shown in FIG. 5)).

In addition, the second shape sealing line 340 formed on the top surface of the circuit board 140 may be formed in a shape corresponding to that of the second housing 160 in order to form the resonance space on the top surface of the circuit board 140.

For example, in a case where the second housing 160 has a substantially reversed “ [symbol] ” shape (one of consonants of korean alphabet or characters) in which the horizontal portion is thin and long while the vertical portion is thick and has a rectangular shape, the second shape sealing line 340 may include a square shape portion 342, a side shape portion 344 formed on one side of the square shape portion 342, and an upper shape portion 346 formed on the upper side of the square shape portion 342.

In the upper shape portion 346, a recess 348 may be formed to not overlap a screw fastening hole 124 of the second housing 120.

Along the peripheral edges of each of the square shape portion 322 and the rectangular shape portion 324 of the first shape sealing line 320, a bottom surface sealing member 330 (as shown in FIG. 7), such as a sealing rib, may be formed.

In addition, along the peripheral edges of each of the square shape portion 342, the side shape portion 344, and the upper shape portion 346 of the second shape sealing line 340, a top surface sealing member 350 (as shown in FIG. 7) may be formed.

As described above, when the first and second shape sealing lines 320 and 340 are formed in the upper and lower regions with reference to the circuit board 140, that is, on the top and bottom surfaces of the circuit board 140, and the bottom surface sealing member 330 and the top surface sealing member 350 are formed on the first and second shape sealing lines 320 and 340 formed as described above, a region for sealing the speaker module 200 is secured.

As the sealing region of the speaker module 200 is secured, the sealing region may be secured to be as wide as possible on the circuit board 140, and a selection width of the sealing may be increased. That is, the first and second sealing lines 320 and 340 may be formed according to the shape of the speaker module 200.

Among the elements mounted on the circuit board 140, the elements, which do not require a shield may be mounted within the sealing regions within the first and second sealing lines 320 and 340. Thus, the arrangement efficiency of the circuit board 140 may be improved.

A speaker mounting state of the electronic device, which has the maximum mounting space on the circuit board and is configured as described above, will be described with reference to FIG. 7.

As illustrated in FIG. 7, in the electronic device having the maximum mounting space on the circuit board according to the present disclosure, the second housing 160, the circuit board 140, and the first housing 120 may be stacked in this order, and the speaker module 200 may be directly mounted on the first housing 120.

At this time, as the speaker module 200, a half-module speaker may be used.

The circuit board 140 includes the first shape sealing line 320 for mounting the speaker module 200 and the second shape sealing line 340 for securing the resonance space.

In addition, as the sealing regions are formed on the top and bottom surfaces of the circuit board 140 by the bottom surface sealing member 330 and the top surface sealing member 350, which are formed along each of the peripheral edges of the square shape portion 322 and the rectangular shape portion 324 of the first shape sealing line 320, and each of the peripheral edges of the square shape portion 342, the side shape portion 344, and the upper shape portion 346 of the second shape sealing line 340, respectively, a sealing region may be formed to be as wide as possible on the circuit board 140, even if the circuit board 140 is cut as a minimum cutout 300 besides the portion corresponding to the speaker mounting portion and the resonance space. Since the elements, which do not require a shield may be mounted within the sealing region produced as described above, the arrangement efficiency of the circuit board 140 may be improved.

As described above, as the sealing regions may be formed above and below the circuit board in the electronic device according to the embodiment of the present disclosure, the arrangement efficiency of the circuit board can be improved and the resonance space for a speaker sound can be secured as much as possible even though a half-module speaker is directly mounted on a main cover. Further, a material cost can be reduced and a design can be made in consideration of manufacturability (DFM), productivity, or processes.

While this disclosure has been particularly shown and described with reference to embodiments thereof, it will be understood by those skilled in the art that various changes in form and details may be made therein without departing from the spirit and scope of this disclosure as defined by the appended claims.

What is claimed is:

1. An electronic device having a speaker, comprising:
a first housing;
a circuit board disposed inside the first housing, the circuit board having a top surface and a bottom surface; and
a second housing coupled to the top surface of the circuit board,
wherein the circuit board includes a first shape sealing line that defines a first sealing region configured to receive a speaker module and a second shape sealing line that defines a second sealing region that forms a resonance space.

2. The electronic device of claim 1, wherein the first shape sealing line and the second shape sealing line are formed on the top and bottom surfaces of the circuit board, respectively.

3. The electronic device of claim 2, wherein the first shape sealing line is formed in a shape that corresponds to that of a speaker module so as to directly mount the speaker module in the first housing and to form the resonance space on the bottom surface of the circuit board.

4. The electronic device of claim 3, wherein the first shape sealing line is formed in a shape that includes various shape portions formed by straight lines or curved lines.

5. The electronic device of claim 1, wherein the second shape sealing line is formed in a shape that corresponds to that of the second housing in order to form the resonance space on the top surface of the circuit board.

6. The electronic device of claim 5, wherein the second shape sealing line includes various shape portions formed by at least one of straight lines and curved lines.

7. The electronic device of claim 4, wherein a bottom surface sealing member is formed along a peripheral edge of the first shape sealing line.

8. The electronic device of claim 6, wherein a top surface sealing member is formed along a peripheral edge of the second shape sealing line.

9. The electronic device of claim 1, further comprising a speaker board, wherein a Z-axis position of the speaker board overlaps a Z-axis position of the speaker.

10. The electronic device of claim 3, wherein the speaker module is a half-module speaker.
